(19) United States
(12) Patent Application Publication
(10) Pub. No.: US 2015/0294541 A1
(43) Pub. Date: Oct. 15, 2015

(54) INSTRUMENTED FLEXIBLE WATERSIDE SECURITY BARRIER SYSTEM

(71) Applicants: Jeffrey Vance Wilson, Snohomish, WA (US); Daniel McAlister, Aloha, OR (US); Ian McKissick, Seattle, WA (US)

(72) Inventors: Jeffrey Vance Wilson, Snohomish, WA (US); Daniel McAlister, Aloha, OR (US); Ian McKissick, Seattle, WA (US)

(21) Appl. No.: 14/687,855

(22) Filed: Apr. 15, 2015

Related U.S. Application Data
(60) Provisional application No. 61/979,814, filed on Apr. 15, 2014.

(51) Int. Cl. G08B 13/12

(52) U.S. Cl. CPC G08B 13/124

(57) ABSTRACT

An instrumented flexible waterside security barrier system secures a waterside infrastructure to detect and localize a breach in the barrier caused by an intruder, thereby permitting a user to perform one or more security actions. The system includes a plurality of panels coupled together and disposed in the waterway, each panel having a plurality of optical fibers and a plurality of wire strength members embedded within a polyurethane layer, and a detection system connected to the plurality of panels to monitor the optical fibers in each panel to detect an attenuation of light in any one of the plurality of optical fibers caused by the breach. The detection system determines a location of the breach in the optical fibers, thereby permitting the user to perform the one or more security actions in response to the breach.

### RELATED APPLICATION

The application claims priority to provisional patent application U.S. Ser. No. 61/979,814 filed on Apr. 15, 2014, the entire contents of which is herein incorporated by reference.

### BACKGROUND

The embodiments herein relate generally to the security of waterside infrastructure.

The watersides of critical infrastructure and commercial or military ports are vulnerable to attacks from surface craft, swimmers or divers. Therefore, there is a need for a system to establish and monitor security perimeters of this infrastructure enabling detection and localization of intrusions so that appropriate actions and/or security measures may be taken in response to these security breaches. Current systems for providing waterside security rely on the use of remote sonar, video or radar sensors, physical barriers or alternative sensed physical barriers. However, in many cases remote sensing systems are not practical because most facilities do not have enough restricted water space to use these remote sensors. Remote sensors also are limited by atmospheric conditions, local topography and water conditions. Rigid sensed barriers are limited because they are not sufficiently compliant for floating applications in a waterway and/or they do not provide a reliable means for accurately detecting an intrusion in the barrier, thereby yielding a reduced overall probability of detection and increased incidence of false alarms.

The literature in the field discusses flexible sensed barriers and the challenges of making a survivable marine net whose junctions could not be breached. However, tests show that none of their designs would actually provide reliable, rapid detection and localization of an informed, capable aggressor. They all have inherent vulnerabilities or limitations in their junction designs within the barrier panels that prevent them from providing a high probability of detection (Pd) without also being so sensitive they have a high Nuisance Alarm Rate (NAR). None of the existing sensed barrier devices provide a means to effectively sense the seams between the barrier panels and between the panels and the supporting structure (floating or fixed over water or vertical at the land-water interface) to prevent undetected breaches at those seams. In addition, none of them provide an adequate means to anchor the panels and sense the connection between the panels and the anchors, nor do they provide a compatible means for a gate in the system.

As such, there is a need in the industry for an effective system that reliably provides the rapid detection and localization of an intrusion in a waterside barrier that extends from the surface to the seafloor, may be fully integrated with the landside security perimeter to provide full coverage of the waterfront facility, and includes a gate feature compatible with a wide range of waterfront configurations.

### SUMMARY

An instrumented flexible waterside security barrier system for use in a waterway to secure a waterside infrastructure is provided. The barrier system comprises a barrier disposed in the waterway to surround a perimeter area of the waterside infrastructure. The barrier is configured to detect and localize a breach in the barrier caused by an intruder with enhanced reliability and accuracy to permit a user to perform one or more security actions.

The barrier system comprises a plurality of panels coupled together and disposed in the waterway, each panel comprising a first set of substantially parallel members coupled to a second set of substantially parallel members at junctions to form a grid-like pattern, each member in the first set of members and the second set of members comprising a plurality of optical fibers and a plurality of wire strength members embedded within a polyurethane layer, and a detection system operably connected to the plurality of panels and configured to monitor the plurality of optical fibers in the first set of members and the second set of members in each panel to detect an attenuation of light in any one of the plurality of optical fibers caused by the breach, wherein the detection system is configured to determine a location of the breach in one of the plurality of optical fibers, thereby permitting the user to perform the one or more security actions in response to the breach.

In certain embodiments, the instrumented flexible waterside security barrier system has the ability to anchor the barrier securely to the seafloor or suspend it in the water column, and to configure panels to function as a gate in a wide variety of waterfront environments.

In certain embodiments, the panels may comprise electrical sensing elements. In these embodiments, upon receipt of an alarm due to a breach in a panel, these electrical conductors may be used to apply increased current flow out from the electrical short to the environment to create a range of electrical fields at the breach that can yield a variety of physiological effects as required.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a schematic view of certain embodiments of the instrumented flexible waterside security barrier system shown in use;

FIG. 2 depicts a perspective view of certain embodiments of the instrumented flexible waterside security barrier system shown in use;

FIG. 3 depicts a perspective view of certain embodiments of the instrumented flexible waterside security barrier system shown in use;

FIG. 4 depicts a front view of certain embodiments of the instrumented flexible waterside security barrier system;

FIG. 5 depicts a perspective view of certain embodiments of the instrumented flexible waterside security barrier system shown in use;

FIG. 6 depicts a front view of a panel used in certain embodiments of the instrumented flexible waterside security barrier system;

FIG. 7 depicts a perspective view of a junction in a panel in certain embodiments of the instrumented flexible waterside security barrier system;

FIG. 8 depicts a sectional view of the panel in certain embodiments of the instrumented flexible waterside security barrier system;

FIG. 9 depicts a sectional view of an alternative panel in certain embodiments of the instrumented flexible waterside security barrier system;

FIG. 10 depicts an exploded view of the junction of the alternative panel in certain embodiments of the instrumented flexible waterside security barrier system;

FIG. 11 depicts a perspective view of the junction of the alternative panel in certain embodiments of the instrumented flexible waterside security barrier system;

FIG. 12 depicts a perspective view of the junction of the alternative panel in certain embodiments of the instrumented flexible waterside security barrier system;

FIG. 13 depicts a perspective view of the junction of the alternative panel in certain embodiments of the instrumented flexible waterside security barrier system;

FIG. 14 depicts a sectional view of an alternative panel in certain embodiments of the instrumented flexible waterside security barrier system;

FIG. 15A depicts a front view of a saddle used with the panel in certain embodiments of the instrumented flexible waterside security barrier system;

FIG. 15B depicts a sectional view of the saddle used with the panel in certain embodiments of the instrumented flexible waterside security barrier system taken along line 15B-15B in FIG. 15A;

FIG. 16 depicts a perspective view of a lacing harness used in certain embodiments of the instrumented flexible waterside security barrier system;

FIG. 17 depicts a front view of the lacing harness used in certain embodiments of the instrumented flexible waterside security barrier system;

FIG. 18 depicts a front view of the lacing harness used in certain embodiments of the instrumented flexible waterside security barrier system shown in use;

FIG. 19 depicts a sectional view of an upper seam assembly used in certain embodiments of the instrumented flexible waterside security barrier system;

FIG. 20 depicts a perspective view of a segmented anchor assembly used in certain embodiments of the instrumented flexible waterside security barrier system;

FIG. 21 depicts a perspective view of a segmented anchor assembly used in certain embodiments of the instrumented flexible waterside security barrier system;

FIG. 22 depicts a perspective view of certain embodiments of the instrumented flexible waterside security barrier system demonstrating the operation of the reefing system;

FIG. 23 depicts a schematic view of the reefing system used in certain embodiments of the instrumented flexible waterside security barrier system; and

FIG. 24 depicts a schematic view of the electrical components of the reefing system used in certain embodiments of the instrumented flexible waterside security barrier system.

### DETAILED DESCRIPTION OF CERTAIN EMBODIMENTS

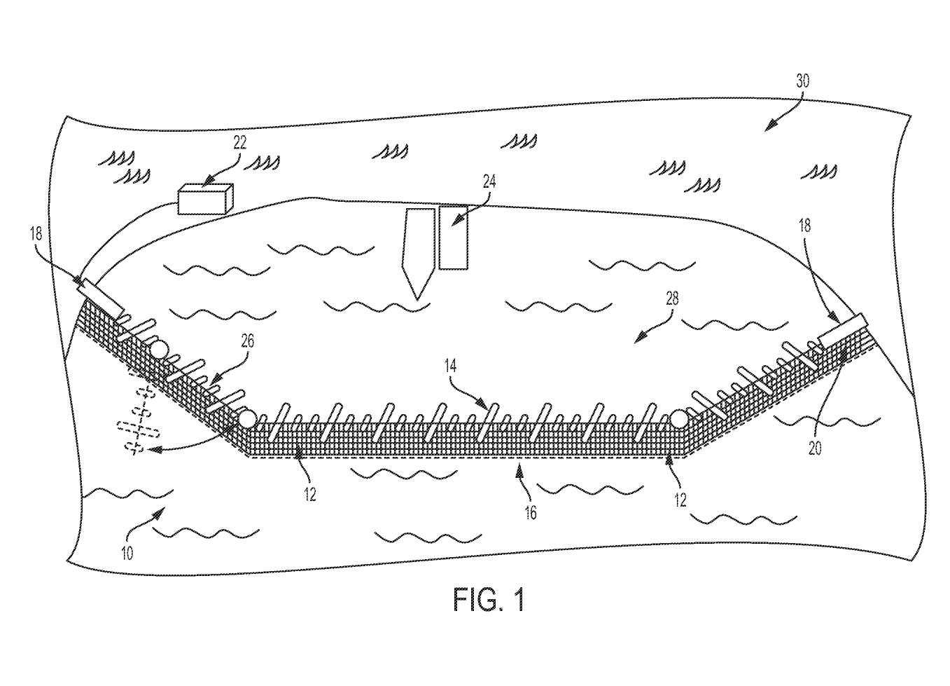

As depicted in FIG. 1, the instrumented flexible waterside security barrier (“IFWSB”) system 10 is configured to protect a waterside infrastructure such as waterfront facility 24 located near water 28 and land 30. Water 28 may be any body of water including, but not limited to, oceans, rivers, channels, or the like. IFWSB system 10 protects the perimeter area of waterfront facility 24 and comprises instrumented net panels 12, barrier support floats 14, segmented anchors 16 and detection and alarm system 22. Instrumented net panels 12 may be connected to land-water interface 18 and land-water interface piers 20. The instrumented net panels 12 are operably connected to detection and alarm system 22, which monitors instrumented net panels 12 for breaches from intruders such as divers, swimmers, surface craft, or the like. Detection and alarm system 22 is configured to accurately detect and determine the exact location of a breach in one or more instrumented net panels 12. In one embodiment, instrumented net panels 12 comprise a swinging gate section 26. Swinging gate section 26 can be opened to create a pathway in the connected instrumented net panels 12 for traffic to pass through or closed to block the pathway.

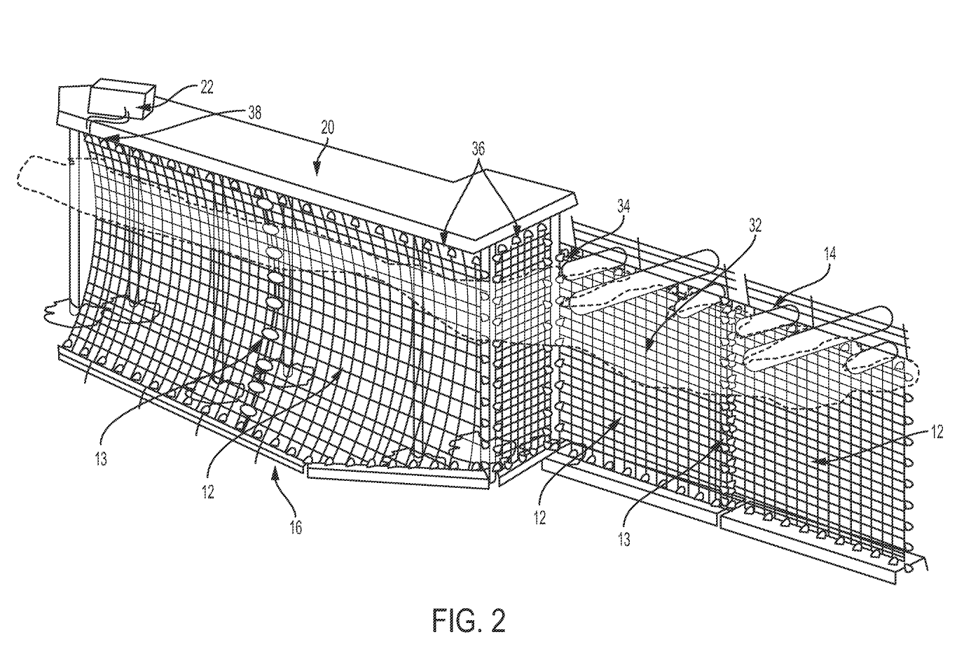

As depicted in FIG. 2, an exemplary embodiment of IFWSB system 10 comprises a plurality of instrumented net panels 12 connected together on panel-to-panel seams 13. One or more instrumented net panels 12 are connected to a fixed structure such as land-water interface pier 20 on horizontal structure seams 36 and/or vertical structure seams 34. Instrumented net panels 12 can be connected to alternative fixed structures such as bridges, oil platforms, or the like. One or more instrumented net panels 12 are connected to barrier support floats 14, which are located above water surface 32. Barrier support floats 14 may be any floating member such as port security barriers, moored ships, or the like. The bottom of each instrumented net panel 12 is connected to a segmented anchor 16 that secures the panel to the seafloor. Each instrumented net panel 12 is connected to detection and alarm system 22 by cables 38, which may run along the shore, pier or land as required. The instrumented net panels 12 with their supports, anchors and seams are considered the Wet-End Segment. Detection and alarm system 22 and the connecting infrastructure are considered the Shore-End Segment.

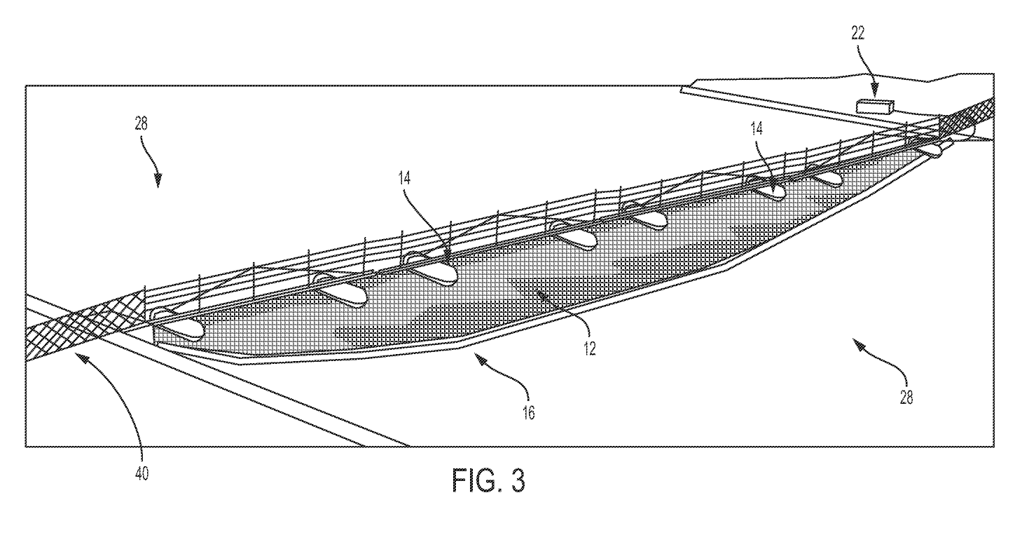

It shall be appreciated that IFWSB system 10 may be configured in many ways, as required by the nature of the waterfront assets to be protected. IFWSB system 10 can either be entirely waterborne (surround assets) or it can cross the land-water interface to link directly to land-side security systems to eliminate gaps in the facility security perimeter. As depicted in FIG. 3, an embodiment of IFWSB system 10 is illustrated with instrumented net panels 12 disposed in water 28 such as a channel. In this embodiment, IFWSB system 10 may be connected to landside security barrier 40 such as a fence.

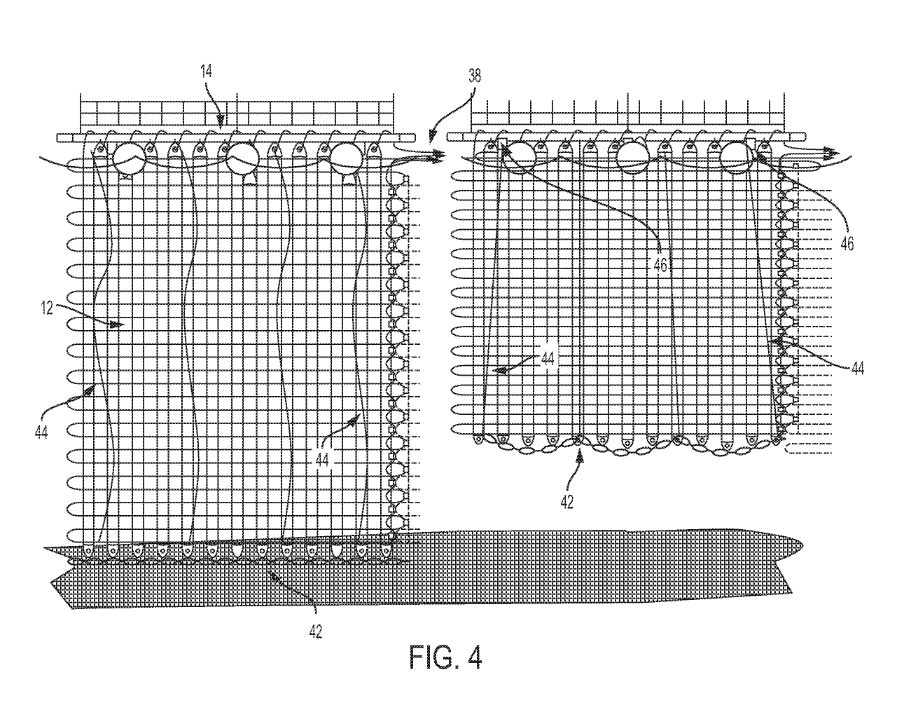

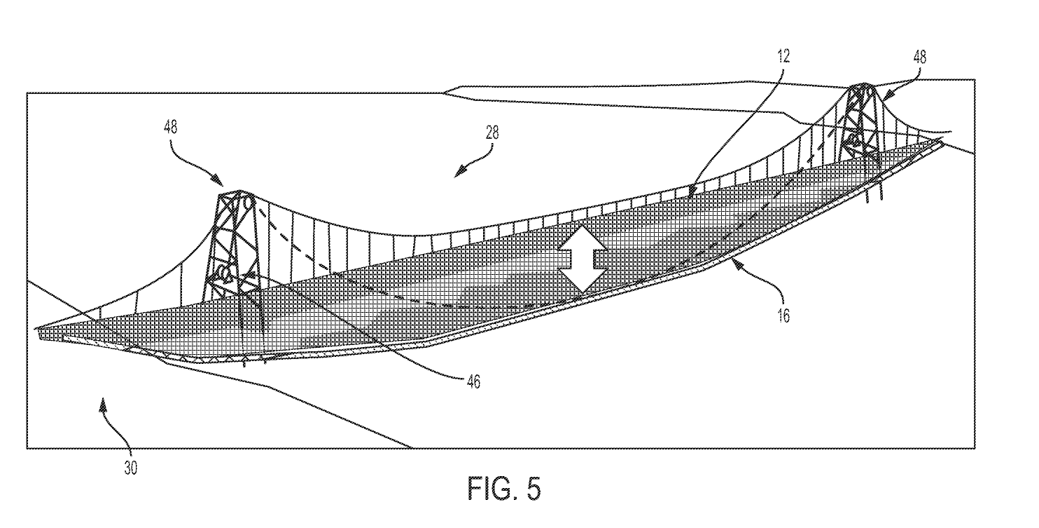

IFWSB system 10 will generally extend from above the surface to the bottom of the body of water to provide a fully secure barrier plane. However, if the water is deeper than the adversary threat can descend, IFWSB system 10 may only extend to that depth, in which case just a depressor weight (chain) is required. As depicted in FIG. 4, an exemplary instrumented net panel 12 is connected to anchor chain 42, which can temporarily secure the panel to the seafloor. Chain reefing winches 46 are mounted to barrier support floats 14 that are connected to instrumented net panel 12. Chain reefing lines 44 comprise first ends connected to chain reefing winches 46 and second ends connected to anchor chain 42. Winches 46 may be operated to lower anchor chain 42 to the seafloor or mid-water, thereby suspending instrumented net panel 12 in the water. As depicted in FIG. 5, IFWSB system 10 is shown with instrumented net panels 12 connected to support towers 48. Chain reefing winches 46 are mounted to support towers 48 to raise and lower instrumented net panels 12 as part of an operable gate to permit a vessel to pass through. In this embodiment, chain reefing winches 46 are connected to the upper edges of instrumented net panels 12 by lines. The lower edges of instrumented net panels 12 remain connected to segmented anchors 16 on the seafloor. The winches are operated to lower instrumented net panels 12 into the water to provide sufficient space to permit the vessel to pass through. The winches are operated to raise instrumented net panels 12 to the original position to close the gate of instrumented net panels 12 after the vessel passes through.

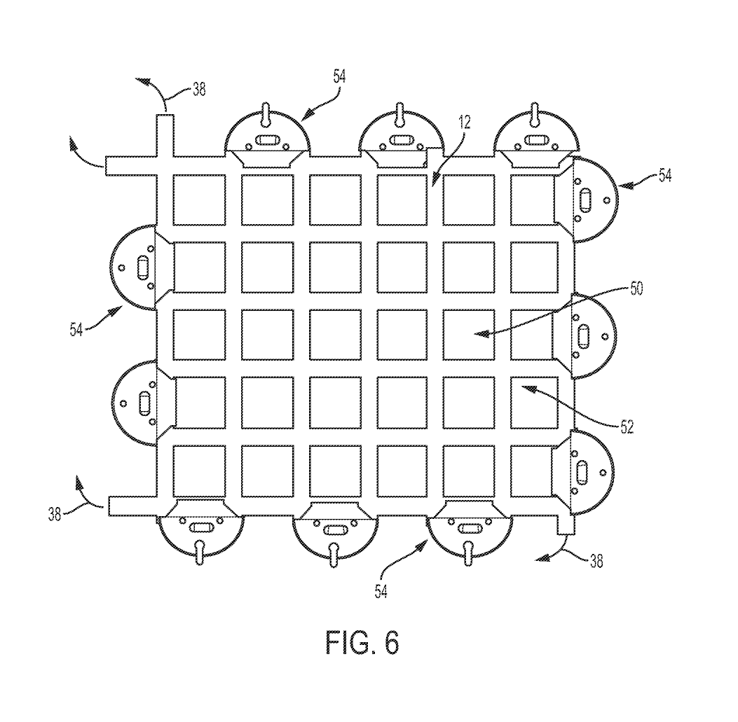

As depicted in FIG. 6, an exemplary instrumented net panel 12 is shown with a plurality of members connected to form a grid-like pattern. Generally, a first set of parallel members are connected to a second set of parallel members to create panel grid openings 50 and panel junctions 52. The choice of the grid size (openings in the net), strength of materials and shape of each instrumented net panel 12 are determined by the particular application requirements. These include the nature of the adversary threat (skill of attackers, kinetic energy of possible vessel attacks), environmental restrictions, and required standoff distance from the protected assets and local environmental loads expected (wind, waves, current, biofouling, site depths, slopes, and bottom type). It shall be appreciated that the technologies used may be assembled to provide the level of protection required for even the most valuable waterfront assets and aggressive adversary.

Saddles 54 are connected to the top edge, bottom edge and side edges of each in-strumented net panel 12. Saddles 54 located on the upper edge of the panel are connected to structures such as barrier support floats 14 or land-water interface piers 20. Saddles 54 located on the side edges of the panel are connected to corresponding saddles 54 of adjacent instrumented net panels 12. Saddles 54 located on the lower edge of the panel are connected to anchor chain 42 or segmented anchors 16. In a preferred embodiment, instrumented net panels 12 are approximately 25-50 feet wide and about 1.1× the water depth tall (usually 20-60 ft). However, the dimensions of each panel may vary. The corners of each instrumented net panel 12 may be connected to cables 38 (not shown), which may comprise commercial optical fiber cables. Cables 38 are connected to detection and alarm system 22.

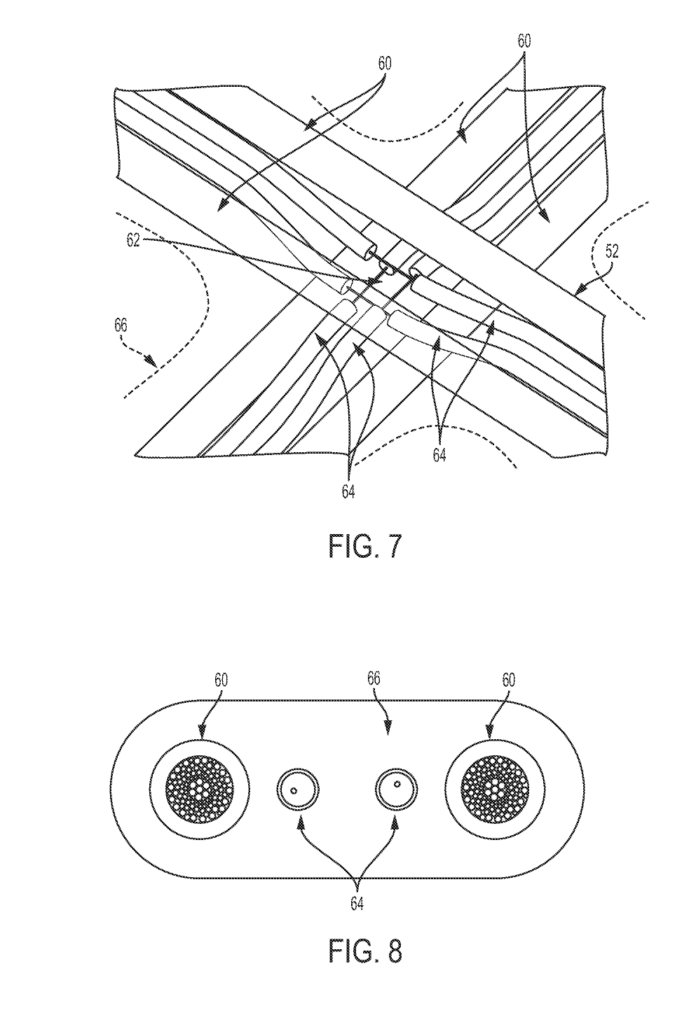

FIG. 7 depicts one exemplary panel junction 52 of instrumented net panel 12. As depicted in the FIG. 8 cross-sectional view, each member in the first set and second set of members of instrumented net panel 12 comprises optical fibers 64 and steel strength members 60 embedded within polyurethane overmold 66. Steel strength members 60 are wire members that may have jackets and have an approximate diameter of ⅛”. Although the figures depict a pair of optical fibers 64 and a pair of steel strength members 60 used in each member, the number and types of these components may vary. At panel junction 52, steel strength members 60 and optical fibers 64 of crossing members are intertwined.

The arrangement of optical fibers 64 with respect to each other and to steel strength members 60 is essential to the successful operation of panel junctions 52. By overlapping optical fibers 64 at each junction, the assembly makes it impossible to either spread each panel junction 52 apart or disassemble them in the field to produce an increase in size of panel grid openings 50 (allow a breach) without faulting optical fibers 64 as detected by detection and alarm system 22.

It shall be appreciated that it is essential to space optical fibers 64 correctly to keep the bend radius at the crossings large enough to prevent unacceptable accumulations of optical losses through the plurality of panel junctions 52. At each panel junction 52, an additional process to remove the fiber jackets at the junction (by melting) may be applied to increase defeat resistance if the adversary threat so warrants. FIG. 7 illustrates exposed portions 62 of optical fibers 64 at panel junction 52 after the melting process.

Monitoring of the electrical properties of the steel strength members 60 also provides an early indication of any underwater attempt to tamper with panel junctions 52 because the damage to the outer polyurethane overmold 66 creates a short to seawater that is detected by detection and alarm system 22. Any alarm resulting from a breach detected by detection and alarm system 22 alerts appropriate response forces and may allow them to react even before a covert breach is complete.

In a preferred embodiment, detection and alarm system 22 is generally located on land 30, but the system may be situated in a variety of alternative locations including, but not limited to, piers, ships, or the like. Detection and alarm system 22 may comprise any electrical and computing components known in the field that are configured to monitor and detect intrusions in instrumented net panels 12. Detection and alarm system 22 comprises at least a power meter and an optical time-domain reflectometer (“OTDR”). The power meter continuously monitors optical fibers 64 in instrumented net panels 12 and rapidly detects when there is a breach in a portion in the fibers due to an attenuation of light. The power meter then generates an alarm in the system, which is transmitted to a user of the detection and alarm system 22. The OTDR uses optical pulses to determine the exact location of the breach within a loop in optical fibers 64. The information generated from the power meter and/or OTDR allows the user to deploy appropriate response forces to the breach in the instrumented net panels 12.

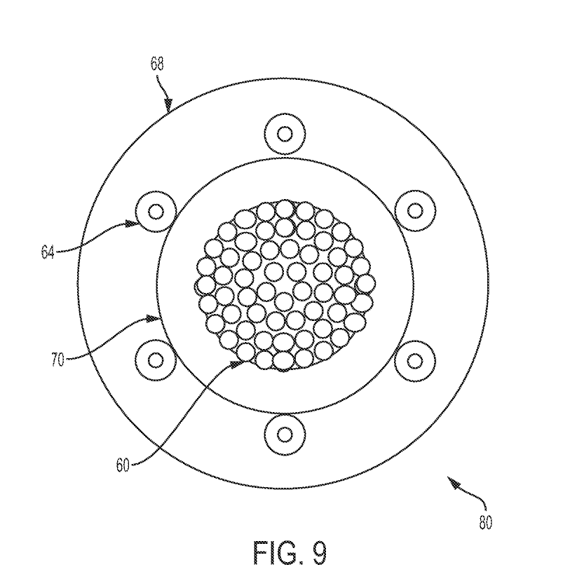

In an alternative embodiment of the invention, electro-optic cables may be used instead to create a desired grid configuration when assembling instrumented net panels 12. As depicted in FIG. 9, a cross-section of electro-optic cable 80 is shown, which comprises outer jacket 68 and inner jacket 70. Optical fibers 64 are embedded within outer jacket 68 and steel strength members 60 are embedded within inner jacket 70. Outer jacket 68 and inner jacket 70 may be made from any materials known in the field such as polyurethane or nylon. Typically, electro-optic cable 80 has a diameter of approximately ¼”. However, the dimensions of electro-optic cable 80 may vary. Optical fibers 64 at the ends of electro-optic cable 80 are connected to detection and alarm system 22 and monitored for breaks/faults.

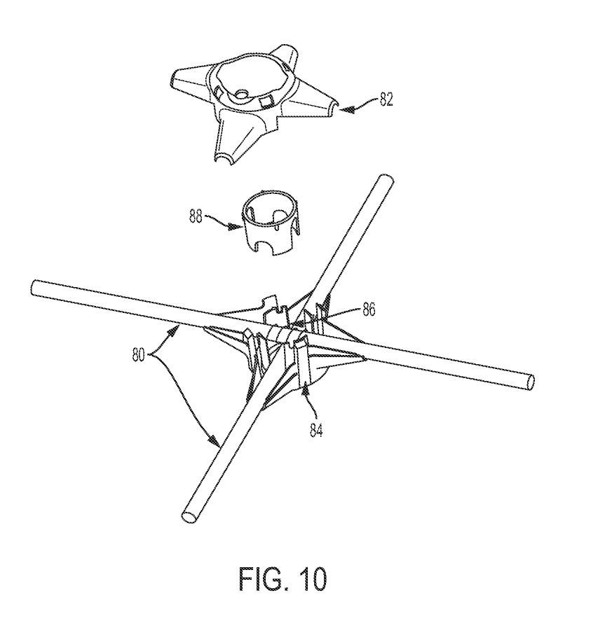

As depicted in FIG. 10, electro-optic cables 80 are secured together at panel junction 52 by using upper junction fastening component 82, lower junction fastening component 84, cup 88 and interlocking springs 86. Upper junction fastening component 82 and lower junction fastening component 84 are matching, pre-molded plastic shells made from polyurethane. Cup 88 is made from a rigid plastic with a melt temperature higher than the jacket material in electro-optic cables 80. Interlocking springs 86 may be made from any metal or alternate material known in the field. The choice of materials used for any of the fastening components depends on the planned application (cable jacket materials, environment, life requirements, etc.).

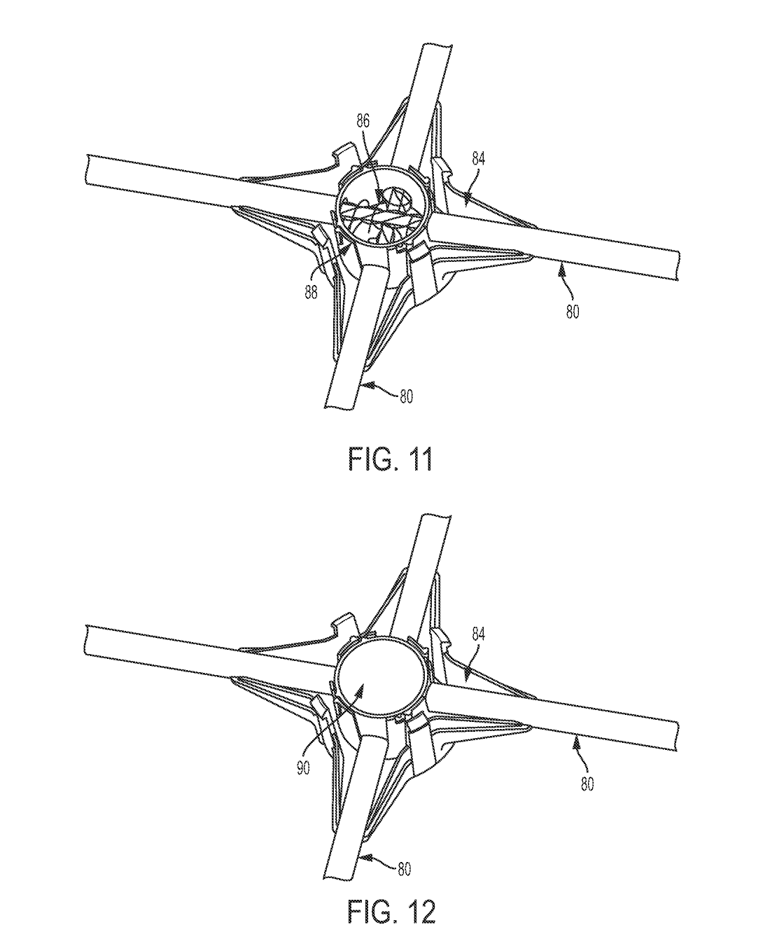

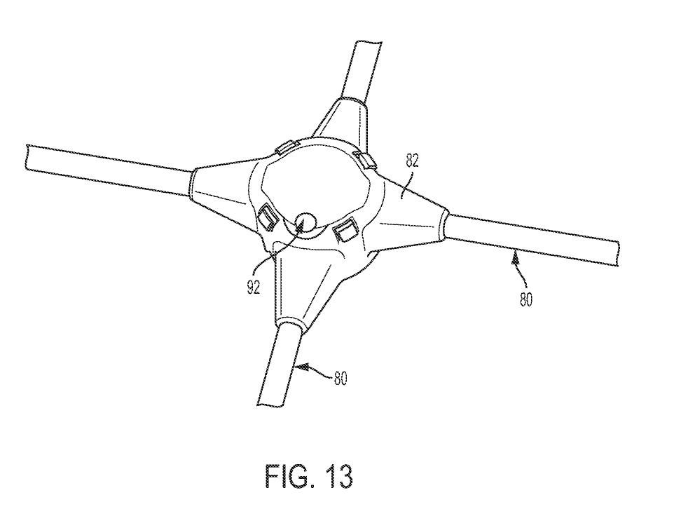

Electro-optic cables 80 are crossed and placed within lower junction fastening component 84. As depicted in FIG. 11, the jackets of the crossed electro-optic cables 80 are melted away and placed within a defined space inside lower junction fastening component 84. Cup 88 comprises openings to permit electro-optic cables 80 to pass through when disposed within lower junction fastening component 84. Interlocking springs 86 are disposed around electro-optic cables 80 at the crossing to secure the cables together. As depicted in FIG. 12, the exposed electro-optic cables 80 are then re-encapsulated in a hard elastomer 90 such as epoxy. As depicted in FIG. 13, upper junction fastening component 82 is placed on top of crossed electro-optic cables 80 and snapped together with lower junction fastening component 84. The remaining internal void in upper junction fastening component 82 and lower junction fastening component 84 is filled by inserting a compliant elastomer such as urethane through opening 92 in upper junction fastening component 82. This urethane filling bonds the assembly together and to the jackets of electro-optic cables 80. The hard reencapsulation process ensures that any attempt to disassemble the fastening components 82, 84 or to simply slide them apart and produce an opening in instrumented net panel 12 will reliably fault the desired number of fibers and set off an associated alarm in detection and alarm system 22.

It shall be appreciated that mechanical separation of the joints in panel junction 52 is not possible with a single slice between the cables because the orientation of optical fibers 64 in the rigid encapsulant eliminates any common plane of separation that could be exploited by a sufficiently skilled and knowledgeable adversary threat. Pulling electro-optic cables 80 through panel junction 52 is not possible without faulting the jacket of the cables because of the inner material bonding to optical fibers 64 and the cable jackets, as well as the interlocking metal springs 86. Each cross-over point of the warp and weft of the panel sensing and strength elements is connected by a unique junction that cannot be separated without at least faulting one or more of optical fibers 64. Lower junction fastening component 84 and upper junction fastening component 82 do not rely on a seawater ground to provide a sensed alarm. Therefore, they work for attacks either above or below water.

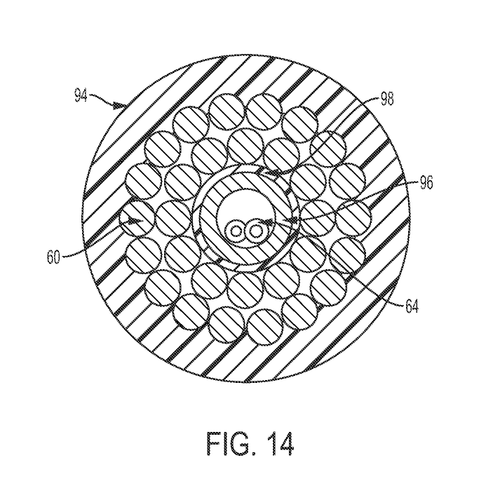

As depicted in FIG. 14, alternative electro-optic cables 80 may be used to construct instrumented net panels 12. In this embodiment, each electro-optic cable 80 comprises inner steel tube 96, plastic tubular jacket 98 and outer plastic jacket 94. Steel strength members 60 are embedded within outer plastic jacket 94 and optical fibers 64 are disposed within inner steel tube 96. In this configuration the electrical resistance of the outer jacket to ground is monitored as the primary indication of a breach, with a fiber optic fault being a secondary indicator. In this configuration electro-optic cables 80 are not melted in upper and lower junction fastening components 82, 84, but are just pressed together and bonded with epoxy. This embodiment is best suited to the application in which it is desirable to increase electrical current flow into the surrounding medium when there is a breach to produce an electric field that affects the attacker.

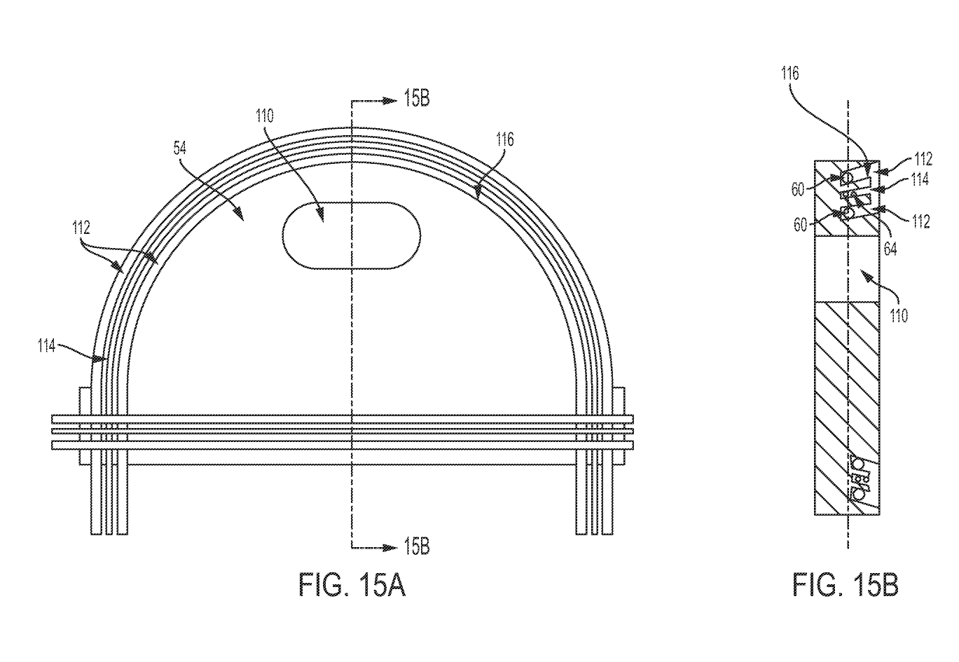

In all embodiments of IFWSB system 10, saddles 54 are used to connect edges of instrumented net panels 12 to other panels, support structures such as barrier support floats 14, land-water interface piers 20 or support towers 48, or segmented anchors 16. As depicted in FIGS. 15A and 15B, each saddle 54 comprises a high-strength plastic member such as glass-filled polyethylene having a semi-circular shape. However, alternative materials can be used for saddle 54.

Each saddle 54 comprises hole 110, steel strength member grooves 112 and optical fibers groove 114. Steel strength member grooves 112 and optical fibers groove 114 are configured to route steel strength members 60 and optical fibers 64 in adjacent members or electro-optic cables 80 in instrumented net panels 12 through a 180 degree turn. Hole 110 in saddle 54 is configured to receive a fastener such as a shackle to secure the top and lower edges of instrumented net panel 12 to barrier support floats 14, land-water interface piers 20, support towers 48 or segmented anchors 16. Alternatively, hole 110 can receive a bolt to secure a pair of saddles 54 located on side edges of adjacent instrumented net panels 12 along panel-to-panel seams 13. In a preferred embodiment, urethane 116 is used to fill the interior of each saddle 54 to create a mold in the assembly.

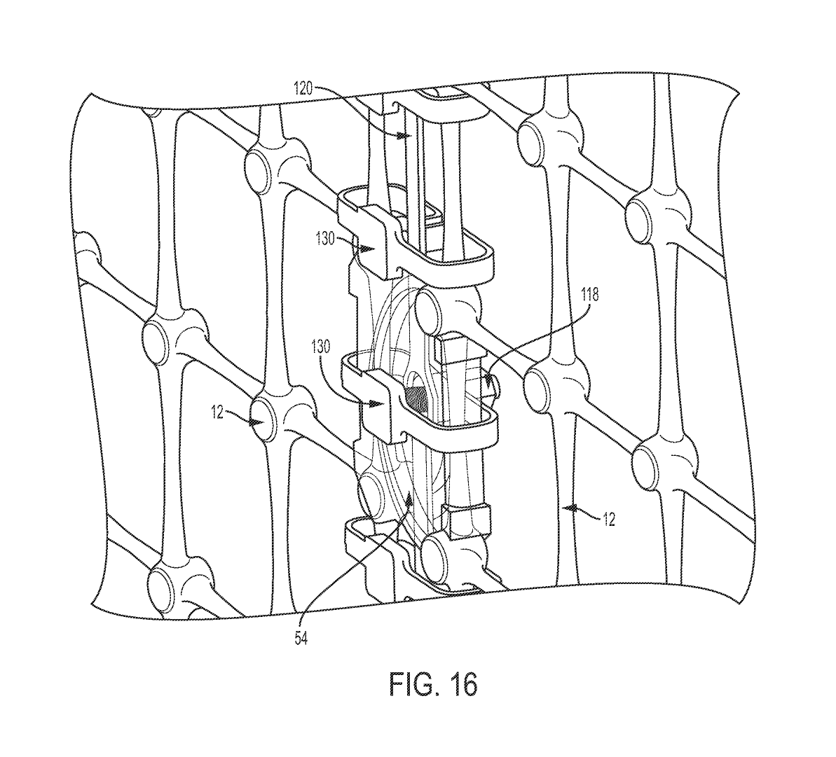

In order to overcome the limitations of existing barrier systems, the instrumented barrier must have seams that meet the same attack resistance and detection performance requirements as the panels themselves. IFWSB system 10 addresses this problem in existing systems by using saddles 54 and lacing harness 120 to secure adjacent instrumented net panels 12 along panel-to-panel seams 13. As depicted in FIGS. 16-18, each saddle 54 located on a side edge of instrumented net panel 12 is secured to a corresponding saddle 54 located on a side edge of an adjacent instrumented net panel 12 by inserting bolt 118 through holes 110 of the pair of saddles 54. This is completed for all saddles 54 located along panel-to-panel seams 13 of adjacent instrumented net panels 12. The installation of bolt 118 through saddles 54 may be performed by technicians above water or divers below water. Next, lacing harness 120 is installed along panel-to-panel seam 13.

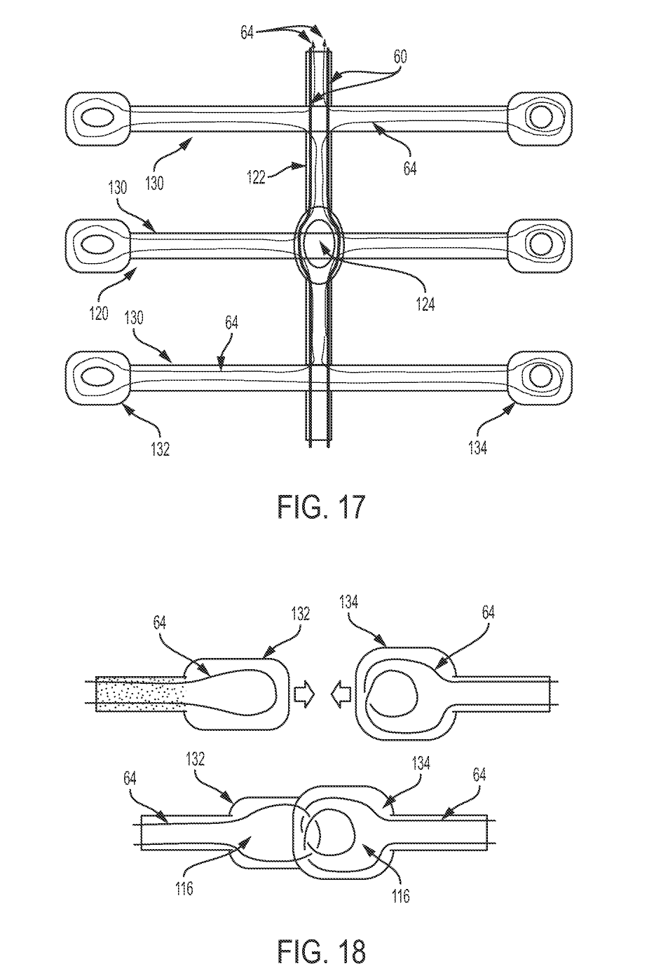

As depicted in FIG. 17, each lacing harness 120 comprises support member 122 and buckles 130. Support member 122 comprises steel strength members 60 and optical fibers 64 embedded within an outer layer such as urethane. Support member 122 comprises hole 124 that can be aligned with holes 110 in saddles 54 to receive bolt 118. Therefore, bolt 118 secures lacing harness 120 to saddles 54.

Buckles 130 comprise first ends 132 and second ends 134, and are secured substantially perpendicular to support member 122. Each buckle 130 is made from plastic and comprises optical fibers 64 looped within from first end 132 to second end 134. First end 132 and second end 134 of each buckle 130 is pulled through adjoining panel grid openings 50 of adjacent instrumented net panels 12 and snapped together as depicted in FIG. 18. Each buckle 130 is then injected with urethane 116 to lock optical fibers 64 together. In this configuration, the portion of optical fibers 64 in first end 132 interlocks with the portion of optical fibers 64 in second end 134. Since optical fibers 64 overlap at the connection, they cannot be disconnected without breaking the fibers. Optical fibers 64 in each seam's lacing harness 120 are monitored by detection and alarm system 22 in the same manner as optical fibers 64 in instrumented net panels 12. It shall be appreciated that a single optical fiber 64 may be routed through support member 122 and buckles 132. Alternatively, multiple optical fibers 64 may be routed through support member 122 and buckles 132.

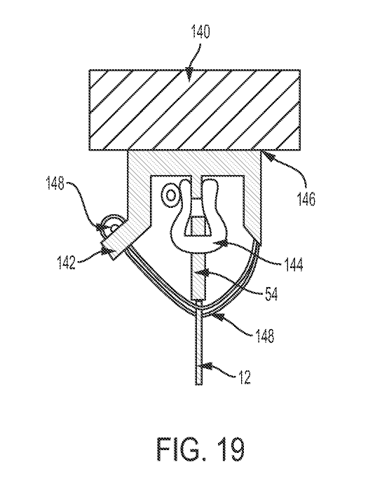

As depicted in the FIG. 19 section view, an upper seam assembly (“USA”) is shown illustrating the connection of an exemplary saddle 54 on the upper edge of instrumented net panel 12 to fixed support structure 140, which may be a pier, bridge, or the like. The upper seam assembly comprises a seam assembly channel 142, which is secured to fixed support structure 140 by weldment 146. Alternatively, a mechanical fastening component such as a bolt can be used instead. Seam assembly channel 142 has a metal rail down the axis with holes to which each saddle 54 on the upper edge of instrumented net panel 12 is shackled by using shackle 144.

The USA walls are hollow and lacing cable 148 is threaded through them to form a loop at panel grid openings 50, with a thimble in each loop end. After saddles 54 are shackled to the seam assembly channel rail, the loops of lacing cable 148 are passed through panel grid openings 50 and into slots in one side of seam assembly channel 142. An end of lacing cable 148 is then threaded through the thimbles to secure them (similar to the rip cord lacing on a parachute). As a result, the instrumented net panel 12 cannot be removed from the upper seam assembly without faulting the optical fiber(s), which is monitored by detection and alarm system 22. It shall be appreciated that lacing cable 148 may be any type of electro-optic cable known in the field having a plurality of steel strength members 60 and a plurality of optical fibers 64 both embedded within an outer layer. It is noted that the USA securement method or the panel-to-panel lacing harness may be used to secure the vertical seams of instrumented net panels 12 at the land-water interface.

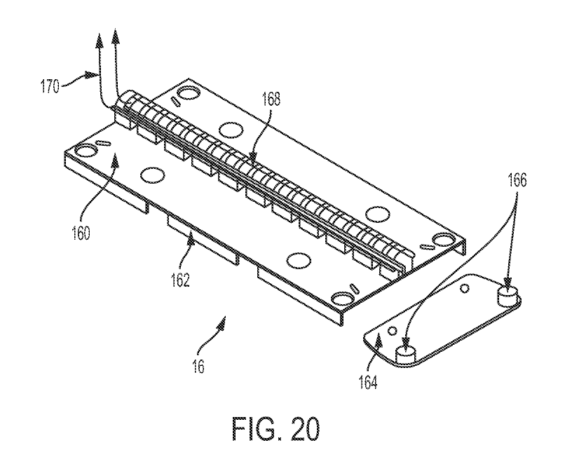

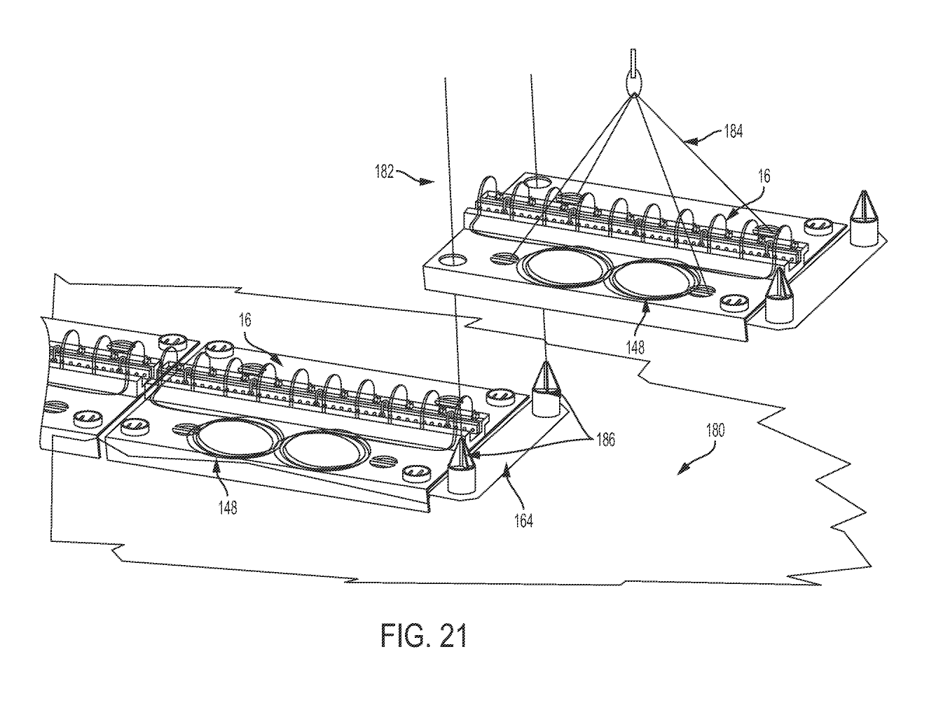

FIGS. 20-21 illustrate components of segmented anchors 16 used to secure the lower edge of instrumented net panels 12 (not shown) to seafloor 180. Each segmented anchor 16 comprises anchor seam assembly 168, which is the same as the upper seam assembly described above. Saddles 54 on the lower edge of each instrumented net panel 12 are connected to anchor seam assembly 168 in the same manner used in the upper seam assembly by using anchor seam lacing cable 170. In some embodiments, one or more additional lacing cables 148 may be used to secure the segmented anchor assembly together. Anchor seam assembly 168 of each segmented anchor 16 is secured to anchor base 160 having anchor skirts 162. Anchor base 160 may be connected to an adjacent segmented anchor 16 via alignment plate 164. Alignment plate 164 has guide cone mounts 166 that are used with guide cones 186 and guidelines 182 by a user to properly align and secure adjacent segmented anchors 16 together. In one embodiment, handling sling 184 may be used by a user to help lower each segmented anchor 16 to seafloor 180. It shall be appreciated that alignment plate 164, guide cones 186 and guidelines 182 help to expedite the installation of the components, improve diver safety and optimize the placement of anchors with respect to the support to control slack in the panels. This helps to minimize loading on the panels from wind, waves, and currents.

It shall be appreciated that segmented anchors 16 are advantageous in securing instrumented net panels 12 to the bottom of the body of water. In particular, these anchor components are preferable over chaining or lacing the panels to concrete clump anchors as used in the current field for the following reasons: 1) Skirted anchors are more efficient and have a better horizontal holding power per pound of weight; 2) Skirted anchors work in a wider range of sediments; and 3) Skirted anchors are wider and more resistant to tunneling. In IFWSB system 10, multiple segmented anchors 16 are interlocked and monitored lacing cables 148 may be crossed over the plurality of segmented anchors 16 connected together. This configuration precludes lifting any single segmented anchor 16 without triggering an alarm as detected by detection and alarm system 22. Since segmented anchors 16 are modular, it is possible to remove and replace a single segment by unlacing lacing cable 148.

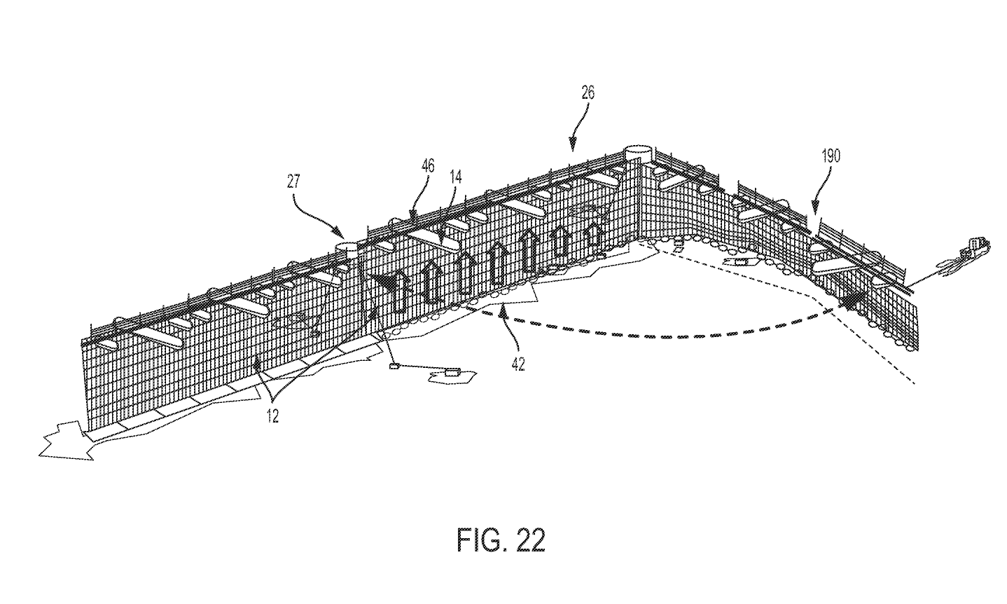

The purpose of IFWSB system 10 is to keep out intruders, but in order to make it a usable system a means of exit and entry for protected vessels is necessary. Since instrumented net panels 12 must be connected together to provide a continuous barrier, the most practical means of providing this access is a swinging gate. Since instrumented net panels 12 typically extend to the seafloor, they must be lifted before the gate can be swung open; hence the need for a reefing system as shown in FIG. 22. The reefing system is used on a section of one or more instrumented net panels 12 connected to anchor chain 42. The reefing system comprises swinging gate section 26, gate latch 27 and one or more chain reefing winches 46 connected to barrier support floats 14.

In the closed position, swinging gate section 26 is coupled to gate latch 27. This forms a continuous barrier formed by instrumented net panels 12 connected together. To open swinging gate section 26, chain reefing winches 46 are operated to raise the instrumented net panels 12 that are part of swinging gate section 26. Swinging gate section 26 is then disengaged from gate latch 27 and pulled open by a vehicle such as a boat to open gate position 190. To close the gate, swinging gate section 26 is swung back to engage with gate latch 27. Chain reefing winches 46 are operated to lower instrumented net panels 12 down as required.

While there are many possible ways to raise/lower instrumented net panels 12 in swinging gate section 26, the preferred embodiment uses a combination of electric winches and batteries mounted on barrier support floats 14. Such a system can be operated remotely, either by command from shore via electrical cable on the surface float system or by a remote trigger similar to a garage door opener. The electric winches are similar in operation to battery-powered bumper winches used in off-road vehicles.

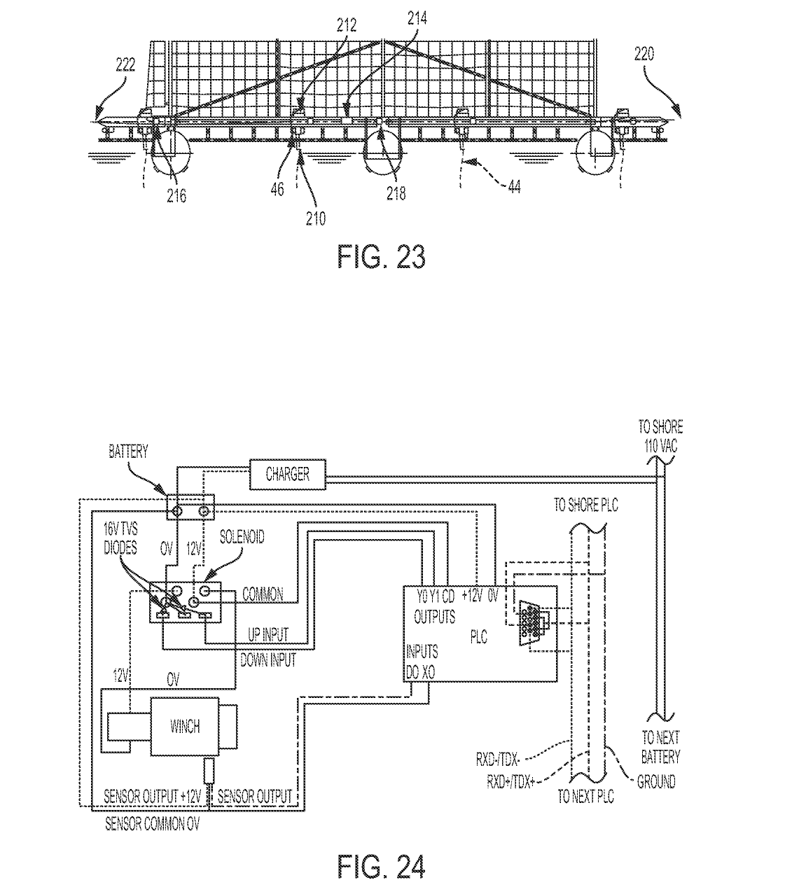

FIG. 23 discloses an exemplary reefing system as mounted on a typical port security barrier. In a preferred embodiment, the reefing system comprises four chain reefing winches 46, coupled to four marine batteries, each battery stored in a separate battery box 212. The marine batteries are coupled to battery charger 216 and charger junction box 218. Controller unit 214 is electrically coupled to each chain reefing winch 46 to operate the device. Each chain reefing winch 46 is connected to chain reefing line 44, which connects to anchor chain 42 on the seafloor. Steel fairlead 210 is attached to a winch bracket as depicted in the figure. Other barrier support floats 14 and instrumented net panels 12 are outfitted similarly.

It shall be appreciated that connections between components such as winch solenoids and control boxes may be completed by using water resistant connectors. The reefing system may have a serial connection 222 to another controller unit or serial connection 220 to the shore. FIG. 24 depicts an exemplary electrical schematic of the reefing system. Each winch is electrically coupled to a sensor, battery, solenoid, charger and programmable logic controller (“PLC”). The PLC may be electrically coupled to another shore PLC or next PLC in proximity to the chain reefing system. It shall be appreciated that the type and number of components used may vary depending on the use and application of the reefing system.

To operate IFWSB system 10, instrumented net panels 12 are installed around the waterside perimeter of the asset/facility to be protected. The optical continuity of optical fibers 64 and/or the electrical elements is monitored by detection and alarm system 22. If there is an attack and breach of a portion of an instrumented net panel 12, an alarm is triggered and the local security response forces are notified of the location of the breach. IFWSB system 10 is most effective if the panels are mechanically connected to the rest of the security perimeter at the land-water interface so there is no gap in the security perimeter.

In an alternative embodiment, IFWSB system 10 can also be used in terrestrial applications where the improved detection and localization capability is required. The system can serve as a platform for other remote sensors, or the optical fibers can themselves be treated as more than contact sensors by monitoring strains along the fibers to sense acoustic disturbances. The system can be used as a barrier against natural hazards such as debris, as well as man-made threats.

It shall be appreciated that the components of IFWSB system 10 described in several embodiments herein may comprise any alternative known materials in the field and be of any color, size and/or dimensions. It shall be appreciated that the components of IFWSB system 10 described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An instrumented flexible waterside security barrier system for use in a waterway to secure a waterside infrastructure, the barrier system comprising a barrier disposed in the waterway to surround a perimeter area of the waterside infrastructure, the barrier being configured to detect and localize a breach in the barrier caused by an intruder with enhanced reliability and accuracy to permit a user to perform one or more security actions, the barrier system comprising:
a plurality of panels coupled together and disposed in the waterway, each panel comprising a first set of substantially parallel members coupled to a second set of substantially parallel members at junctions to form a grid-like pattern, each member in the first set of members and the second set of members comprising a plurality of optical fibers and a plurality of wire strength members embedded within a polyurethane layer; and
a detection system operably connected to the plurality of panels and configured to monitor the plurality of optical fibers in the first set of members and the second set of members in each panel to detect an attenuation of light in any one of the plurality of optical fibers caused by the breach, wherein the detection system is configured to determine a location of the breach in the one of the plurality of optical fibers, thereby permitting the user to perform the one or more security actions in response to the breach.

2. The barrier system of claim 1, further comprising a plurality of semi-circular saddle components coupled to an upper edge, a lower edge, a first side edge and a second side edge of each panel, each semi-circular saddle component comprising a first set of grooves configured to receive the plurality of wire strength members of adjacent members in the first set of parallel members or adjacent members in the second set of parallel members, and a second groove configured to receive the plurality of optical fibers of adjacent members in the first set of parallel members or adjacent members in the second set of parallel members.

3. The barrier system of claim 2, wherein a first panel is mechanically coupled to a second panel by fastening the plurality of semi-circular saddle components coupled to the first side edge of the first panel to the plurality of semi-circular saddle components coupled to the second side edge of the second panel.

4. The barrier system of claim 3, further comprising a lacing harness mechanically coupled to both a first semi-circular saddle component of the first panel and a first semi-circular saddle component of the second panel, wherein the lacing harness comprises a support member extending proximate the first side edge of the first panel and the second side edge of the second panel, and a plurality of buckle members coupled substantially perpendicularly to the support member.

5. The barrier system of claim 4, wherein the support member of the lacing harness comprises a plurality of wire strength members and a plurality of optical fibers both embedded within an outer layer, wherein each buckle member of the plurality of buckle members comprises a first end and a second end, each buckle member further comprising an optical fiber disposed therein and extending from the first end to the second end, wherein each buckle member is disposed around a portion of the first side edge of the first panel and a portion of the second side edge of the second panel to permit the first end of the buckle member to couple with the second end of the buckle member.

6. The barrier system of claim 5, wherein a first portion of the optical fiber in the first end of each buckle member interlocks with a second portion of the optical fiber in the second end of each buckle member.

7. The barrier system of claim 6, wherein the interior of each buckle member is filled with urethane.

8. The barrier system of claim 7, wherein the plurality of semi-circular saddle components coupled to the upper edge of each panel is mechanically coupled to a support structure located above the waterway.

9. The barrier system of claim 8, further comprising a plurality of assembly channels coupled to the support structure, each assembly channel coupled to one of the plurality of semi-circular saddle components coupled to the upper edge of each panel.

10. The barrier system of claim 9, further comprising a lacing cable disposed around a portion of the upper edge of each panel and coupled to one of the assembly channels, wherein the lacing cable comprises a plurality of wire strength members and a plurality of optical fibers embedded within an outer layer.

11. The barrier system of claim 10, wherein the plurality of semi-circular saddle components coupled to the lower edge of each panel is mechanically coupled to an anchor chain.

12. The barrier system of claim 10, wherein the plurality of semi-circular saddle components coupled to the lower edge of each panel is mechanically coupled to at least one of a plurality of segmented anchors, each segmented anchor configured to mechanically couple to an adjacent segmented anchor, wherein each segmented anchor is coupled to at least one semi-circular saddle component of the lower edge of each panel by at least one lacing cable.

13. The barrier system of claim 12, wherein the at least one lacing cable securing the segmented anchor to the at least one semi-circular saddle component of the lower edge comprises a plurality of wire strength members and a plurality of optical fibers embedded within an outer layer.

14. The barrier system of claim 13, wherein the detection system comprises a power meter configured to determine the attenuation of light in any one of the plurality of optical fibers, and an optical time-domain reflectometer configured to determine the location of the breach in the one of the plurality of optical fibers.

15. The barrier system of claim 14, wherein the detection system is operably connected to the lacing harness, wherein the power meter is configured to determine an attenuation of light in any one of the plurality of optical fibers in the support member or plurality of buckle members, and the optical time-domain reflectometer is configured to determine a location of a breach in any one of the plurality of optical fibers in the lacing harness.

16. The barrier system of claim 15, further comprising a reefing system operably connected to at least one panel and comprising at least one winch operably connected to a power source and a controller unit, wherein the reefing system is configured to raise and lower the at least one panel to a desired height above a ground surface of the waterway.

17. The barrier system of claim 16, further comprising an upper fastening component me-chanically coupled to a lower fastening component at each junction of each panel to enclose an exposed portion of the plurality of optical fibers in one of the members in the first set and an exposed portion of the plurality of optical fibers in one of the members in the second set.

18. The barrier system of claim 17, further comprising an elastomer disposed within the upper fastening component and the lower fastening component at each junction to embed the exposed portions of optical fibers in the one of the members of the first set and the one of the members of the second set.

19. The barrier system of claim 18, wherein each member in the first set of substantially parallel members and the second set of substantially parallel members comprises an outer jacket and an inner jacket, wherein the plurality of optical fibers are embedded in the outer jacket and the plurality of wire strength members are embedded within the inner jacket.

20. The barrier system of claim 18, wherein each member in the first set of substantially parallel members and the second set of substantially parallel members comprises an outer jacket disposed around an inner tubular member, wherein the plurality of wire strength members are embedded within the outer jacket and the plurality of optical fibers are disposed within the inner tubular member.
